(19) United States
(12) Patent Application Publication
(10) Pub. No.: US 2002/0013252 A1
(43) Pub. Date: Jan. 31, 2002

(54) Particulate composite material for the controlled release of an active ingredient

(76) Inventors: Peter Schmiedel, Duesseldorf (DE); Maren Jekel, Duesseldorf (DE); Thomas Gassenmeier, Duesseldorf (DE); Wolfgang Von Rybinski, Duesseldorf (DE); Arnd Kessler, Leverkusen (DE)

Correspondence Address: Glenn E.J. Murphy, Henkel Corporation, Patent Law Dept., 2500 Renaissance Blvd., Suite 200, Gulph Mills, PA, 19406, US

(21) Appl. No.: 09/729,007

(22) Filed: Dec. 4, 2000

(30) Foreign Application Priority Data
Dec. 4, 1999 (DE) 199 58 472.9

(51) Int. Cl. C11D 17/00

(52) U.S. Cl. 510/446; 510/451; 510/470; 510/473

(57) ABSTRACT

A particulate composite material for the controlled release of an active ingredient is claimed, comprising an active ingredient or an operation which comprises this active ingredient in a mixture with an LCST substance, where the material remains at least partially unchanged upon passing through one or more heat treatments in a liquid medium, and after cooling following the heat treatment the active ingredient is released.

The present invention relates to a particulate composite material for the release of an active ingredient, comprising an active ingredient or a preparation which comprises the active ingredient in a mixture with an LCST substance; to the use of this composite material in various applications, and to a detergent or cleaner which comprises the composite material.

The controlled release of active ingredients plays a role wherever the active ingredient should not develop its effect immediately after introduction, but only in a later stage of a multistage process. Active ingredients which are only to be metered in in a later stage often have to be introduced manually.

In the pharmaceutical sector, in the case of active ingredients which are to be administered perorally, the different solubility behavior of polymers in the acidic and alkaline environment, i.e. such as in the stomach and in the intestine, is exploited by using such polymers for the coating of tablets, etc. Medicaments which should pass into the intestine are usually coated with an enteric polymer, which only dissolves in the intestine.

In other processes, temperature curves are passed through, thus, for example, during the sterilization and pasteurization of foods.

Washing and cleaning processes also have two or more heating and cooling phases, where, particularly in the last process stage, in the so-called clear-rinse cycle, different active ingredients are added. In customary washing and cleaning processes, these active ingredients are usually added as separate agents, and are not present in the actual detergent or cleaner.

International patent application WO 98/49910 discloses an encapsulated material where at least some of the material is encapsulated during a heat treatment in an aqueous environment and is released after cooling following this heat treatment. This material is coated with one layer of a hydrophobic film-forming material and one layer of a material having a lower critical separation temperature (LCST) below the temperature of the heat treatment. One possible application of the disclosed encapsulated materials is the food industry, where this material is used in foods which are sterilized.

The application of layers is industrially very complex and, in the case of the manufacture of particulate materials, requires an additional operation.

The object of the present invention was to provide a material which comprises an active ingredient which is released in a process which passes through two or more temperature stages only after a heat treatment, if the material is used in a process in liquid media, and which can be prepared in a simple manner.

Surprisingly, we have found that active ingredients which pass through one or more temperature stages can be released only after a heat treatment if such active ingredients or active ingredient preparations are mixed with an LCST substance and further processed to give particles.

The present invention provides a particulate composite material for the controlled release of an active ingredient, comprising an active ingredient or a preparation which comprises this active ingredient in a mixture with an LCST substance, where the material remains at least partially unchanged upon passing through one or more heat treatments in a liquid medium, and after cooling following the heat treatment the active ingredient is released.

LCST substances are substances which have better solubility at lower temperatures than at higher temperatures. They are also referred to as substances with a lower critical separation temperature. These substances are usually polymers. Depending on the application conditions, the lower critical separation temperature should be between room temperature and the temperature of the heat treatment, for example between 20° C., preferably 30° C. and 100° C., in particular between 30° C. and 50° C. The LCST substances are preferably chosen from alkylated and/or hydroxyalkylated polysaccharides, cellulose ethers, polyisopropylacrylamide, copolymers of polyisopropylacrylamide, and blends of these substances.

Examples of alkylated and/or hydroxyalkylated polysaccharides are hydroxypropylmethylcellulose (HPMC), ethyl(hydroxyethyl)cellulose (EHEC), hydroxypropylcellulose (HPC), methylcellulose (MC), ethylcellulose (EC), carboxymethylcellulose (CMC), carboxymethylmethylcellulose (CMMC), hydroxybutylcellulose (HBC), hydroxybutylmethylcellulose (HBMC), hydroxyethylcellulose (HEC), hydroxyethylcarboxymethylcellulose (HECMC), hydroxyethylethylcellulose (HEEC), hydroxypropylcarboxymethylcellulose (HPCMC), hydroxyethylmethylcellulose (HEMC), methylhydroxyethylcellulose (MHEC), methylhydroxyethylpropylcellulose (MHEPC) and propylcellulose (PC) and mixtures thereof, preference being given to carboxymethylcellulose, methylcellulose, methylhydroxyethylcellulose and methylhydroxypropylcellulose, and the alkali metal salts of the CMC or the readily ethoxylated MC or mixtures of the above.

Further examples of LCST substances are cellulose ethers, and mixtures of cellulose ethers with carboxymethylcellulose (CMC). Further polymers which exhibit a lower critical separation temperature in water and which are also suitable are polymers of mono- or di-N-alkylated acrylamides, copolymers of mono- or di-N-substituted acrylamides with acrylates and/or acrylic acids or mixtures of networks of the abovementioned (co)polymers intertwined with one another. Also suitable are polyethylene oxide or copolymers thereof, such as ethylene oxide/propylene oxide copolymers and graft copolymers of alkylated acrylamides with polyethylene oxide, polymethacrylic acid, polyvinyl alcohol and copolymers thereof, polyvinyl methyl ether, certain proteins, such as poly(VATGVV), a repeating unit in the natural protein elastin and certain alginates. Mixtures of these polymers with salts or surfactants can likewise be used as LCST substance. As a result of such additions or by means of the degree of crosslinking of the polymers it is possible to modify the LCST (lower critical separation temperature) accordingly.

In a preferred embodiment of the present invention, the active ingredients used according to the invention are coated with a further material which is soluble at a temperature above the lower separation temperature of the LCST substance or have a melting point above this temperature or delayed solubility, i.e. can be released above the lower separation temperature of the LCST layer. This layer serves to protect the mixture of active ingredient and LCST substance from water or other media which can dissolve these prior to heat treatment. This further layer should not be liquid at room temperature and preferably has a melting point or softening point at a temperature equal to or above the lower critical separation temperature of the LCST polymer. The melting point of this layer is particularly preferably between the lower critical separation temperature and the temperature of the heat treatment. In a particular embodiment of this variant, the LCST polymers and the further substance are mixed together and applied to the material to be encapsulated.

Depending on the application, the further substance preferably has a melting range between about 35° C. and about 75° C. This means in the present case that the melting range occurs within the given temperature interval and does not represent the width of the melting range.

The abovementioned properties are usually satisfied by so-called waxes. “Waxes” means a number of natural or artificially obtained substances which usually melt above 40° C. without decomposition and, at just a little above the melting point, are of comparatively low viscosity and are non-stringing. They have a highly temperature-dependent consistency and solubility. The waxes are divided into three groups depending on their origin: the natural waxes, chemically modified waxes and the synthetic waxes.

The natural waxes include, for example, plant waxes, such as candelilla wax, carnauba wax, japan wax, esparto grass wax, cork wax, guaruma wax, rice germ oil wax, sugarcane wax, ouricury wax, or montan wax, animal waxes, such as beeswax, shellac wax, spermaceti, lanolin (wool wax), or uropygial grease, mineral waxes, such as ceresin or ozokerite (earth wax), or petro-chemical waxes, such as petrolatum, paraffin waxes or microcrystalline waxes.

Chemically modified waxes include, for example, hard waxes, such as montan ester waxes, sassol waxes or hydrogenated jojoba waxes.

Synthetic waxes generally means polyalkylene waxes or polyalkylene glycol waxes. Coating materials which can be used are also compounds from different classes of substance which satisfy said requirements with regard to the softening point. Examples of suitable synthetic compounds which have proven suitable are higher esters of phthalic acid, in particular dicyclohexyl phthalate, which is available commercially under the name Unimoll® 66 (Bayer AG). Also suitable are synthetically prepared waxes from lower carboxylic acids and fatty alcohols, for example dimyristyl tartrate, which is available under the name Cosmacol® ETLP (Condea). Conversely, synthetic or partially synthetic esters of lower alcohols with fatty acids from native sources may also be used. This class of substance includes, for example, Tegin® 90 (Goldschmidt), a glyceryl monostearate palmitate. Shellac, for example Schellack-KPS-Dreiring-SP (Kalkhoff GmbH) may be used.

Within the scope of the present invention, the so-called wax alcohols, for example, are likewise considered to be waxes. Wax alcohols are water-insoluble fatty alcohols of relatively high molecular weight which usually have about 22 to 40 carbon atoms. The wax alcohols occur, for example, in the form of wax esters of relatively high molecular weight fatty acids (wax acids) as a principal constituent of many natural waxes. Examples of wax alcohols are lignoceryl alcohol (1-tetracosanol), cetyl alcohol, myristyl alcohol or melissyl alcohol. The coating of the solid particles coated in accordance with the invention may, if desired, also comprise wool wax alcohols, by which are meant triterpenoid and steroid alcohols, for example lanolin, which is available, for example, under the trade name Argowax® (Pamentier & Co). Within the scope of the present invention, it is also possible to use, at least proportionately, as a constituent of the coating, fatty acid glycerol esters or fatty acid alkanolamides, and also, if desired, water-insoluble or virtually water-insoluble polyalkylene glycol compounds.

Further suitable hydrophobic substances having a melting point above the LCST of the coating material below are saturated aliphatic hydrocarbons (paraffins).

Also suitable as coating materials are all water-soluble, water-dispersible and water-insoluble polymers which have a melting point above the lower critical separation temperature of the LCST polymer used according to the invention, or are soluble above this temperature. Suitable polymers are polyethylene glycols, polyvinyl alcohols, polyacrylic acids and derivatives thereof, and gelatins which are solid at room temperature.

Sometimes, for the protection of the composite material, it may suffice to shield it by a water-soluble coating of initially cold water. This water-soluble coating must merely have sufficiently delayed solubility so that the layer is stable for a sufficiently long period. For this purpose it is possible to use, for example, polyalkylene glycols having, preferably, a relatively high molecular weight.

The composite material according to the invention is prepared in a manner known per se. In one possible embodiment, the LCST substance and the active ingredient are mixed, and optionally processed with further components and auxiliaries to give a particulate material. This processing depends on the aggregate state of the constituents to be mixed. If, for example, one of the constituents is in solid form and the other is in liquid form, then the solid constituent can serve as a carrier for the liquid constituent. Where all of the components are in solid form, it has proven suitable to compress these particles or to subject them to a granulation process. Depending on the process conditions, the strength of the composite material can be adjusted, which in turn has an influence on the dissolution kinetics of the finished composite material.

An essential advantage of the particulate composite material according to the present invention is that active ingredients are released in a process stage after a heating step. There are a large number of processes in which the individual components pass through a heating step, e.g. in the food, animal feed and also nonfood industry, for example in pasteurization or sterilization processes. In these processes, the heating step serves to destroy micro-organism or to seal the product (e.g. glasses or bottles, etc.). These products cannot be reopened without fresh contamination occurring. Such processes are also used in the pharmaceutical industry, where the products have to be containerized aseptically. The addition of further constituents during or after the aseptic packaging is only possible if these further constituents are also sterile. The release of further constituents after the heating step, without having to open the packaging etc., offers a large number of advantages.

Also in the case of washing and cleaning operations, both in the commercial sector and also domestically, various temperature stages are passed through. Particularly in the case of machine operations, further components are generally added to the clear-rinse cycle, which follow a washing or cleaning stage at elevated temperature. These later process stages are usually clear-rinse cycles in which the users, depending on the operation, add certain active ingredients. The dosing of these active ingredients is usually separate, either manual or via devices specifically intended for this purpose. In the case of these processes too, the composite material according to the invention offers a large number of advantages.

The particulate composite material according to the invention can be used in a large number of applications. Accordingly, a further object of the present invention relates to the use of the above-described composite material in pharmaceutical and cosmetic products, foods, detergents and cleaners, and adhesives.

The active ingredients to be used are matched to the corresponding intended use.

Examples of active ingredients which are only released in a process stage after a heating step are, for example, in the food industry, vitamins, proteins, peptides, hydrolysates, nutritional supplements, etc. Examples of active ingredients which can be used in all heating steps, including outside of the food industry, are dyes, antioxidants, thickeners, enzymes, preservatives, etc.

Suitable active ingredients in detergents and cleaners are enzymes, fragrances, dyes, acids, bleaches and bleach activators or bleach catalysts.

Machine dishwashing detergents comprise, as active ingredient(s), preferably clear-rinse surfactants, surfactants, fragrances, dyes, deposit inhibitors, corrosion inhibitors, or bleaches, preferably an active-chlorine carrier.

Textile detergents comprise, as active ingredient(s), preferably enzymes, fragrances, dyes, fluorescent agents, optical brighteners, antishrink agents, finishing components, anticrease agents, antimicrobial active ingredients, germicides, fungicides, antioxidants, antistats, ironing aids, phobicization agents and impregnation agents, and UV absorbers and fragrances. These active ingredients are formulated according to the invention with an LCST substance and can be incorporated into the composition according to the invention. In the washing process, they are released in a rinse cycle following the main rinse or wash cycle.

The present invention further relates to a detergent or cleaner which comprises surfactants, builders and optionally further customary ingredients and which comprises at least one particulate composite material for the controlled release of an active ingredient or a preparation which comprises the active ingredient in a mixture with an LCST substance, where the composite material remains at least partially unchanged after passing through one or more temperature stages after a heat treatment in a liquid medium and is released after the cooling following the heat treatment.

The detergent or cleaner can be used particularly advantageously in machine processes where it is to be released in a clear-rinse cycle after the washing step. Examples are the machine washing of textiles and machine dishwashing both domestically and in the commercial sector. The incorporated ingredients can be released in a targeted manner in a rinse cycle after the main rinse or wash cycle.

In addition to the active ingredients, the detergents and cleaners comprise, as further ingredients, at least one surfactant, preferably chosen from anionic, nonionic, cationic and amphoteric surfactants. The surfactants are preferably present in an amount of from 0.1 to 50% by weight, preferably from 0.1 to 40% by weight and in particular from 0.1 to 30% by weight, based on the composition.

The nonionic surfactants used are preferably alkoxylated, advantageously ethoxylated, in particular primary alcohols having preferably 8 to 18 carbon atoms and on average 1 to 12 mol of ethylene oxide (EO) per mole of alcohol, in which the alcohol radical may be linear or, preferably, methyl-branched in the 2-position, or may contain linear and methyl-branched radicals in the mixture, as customarily are present in oxo alcohol radicals. However, particular preference is given to alcohol ethoxylates containing linear radicals from alcohols of native origin having 12 to 18 carbon atoms, e.g. from coconut, palm, tallow fatty or oleyl alcohol, and on average 2 to 8 EO per mole of alcohol. Preferred ethoxylated alcohols include, for example, C₁₂₋₁₄-alcohols with 3 EO to 7 EO, C₉₋₁₁₋alcohol with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, such as mixtures of C₁₂₋₁₄-alcohol with 3 EO and C₁₂₋₁₈-alcohol with 7 EO. The degrees of ethoxylation given are statistical average values which, for a specific product, may be an integer or a fraction. Preferred alcohol ethoxylates have a narrowed homologue distribution (narrow range ethoxylates, NRE). In addition to these nonionic surfactants it is also possible to use fatty alcohols having more than 12 EO. Examples thereof are tallow fatty alcohol with 14 EO, 25 EO, 30 EO or 40 EO. Nonionic surfactants which contain EO and PO groups together in the molecule can also be used according to the invention. Block copolymers with EO-PO block units or PO-EO block units can be used here, as can EO-PO-EO copolymers or PO-EO-PO copolymers. It is of course also possible to use mixed alkoxylated nonionic surfactants in which EO and PO units are not distributed in blocks, but randomly. Such products are obtainable by the simultaneous action of ethylene oxide and propylene oxide on fatty alcohols.

Furthermore, further nonionic surfactants which can be used are also alkyl glycosides of the general formula RO(G)ₓ in which R is a primary straight-chain or methyl-branched, in particular methyl-branched in the 2-position, aliphatic radical having 8 to 22, preferably 12 to 18, carbon atoms, and G is the symbol which stands for a glucose unit having 5 or 6 carbon atoms, preferably for glucose. The degree of oligomerization x, which gives the distribution of monoglycosides and oligoglycosides is any desired number between 1 and 10; x is preferably 1.2 to 1.4.

A further class of nonionic surfactants are alkoxylated, preferably ethoxylated or ethoxylated and propoxylated fatty acid alkyl esters, preferably having 1 to 4 carbon atoms in the alkyl chain, in particular fatty acid methyl esters.

Also, nonionic surfactants of the amine oxide type, for example N-cocoalkyl-N,N-dimethylamine oxide and N-tallowalkyl-N,N-dihydroxyethylamine oxide, and of the fatty acid alkanolamides may be suitable. The amount of these nonionic surfactants is preferably no more than that of the ethoxylated fatty alcohols, in particular no more than half thereof.

Further suitable surfactants are polyhydroxy fatty acid amides of the formula I

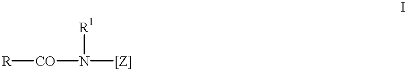

in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula II

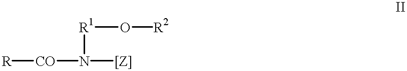

in which R is a linear or branched alkyl or alkenyl radical having 7 to 12 carbon atoms, R¹ is a linear, branched or cyclic alkyl radical or an aryl radical having 2 to 8 carbon atoms, and R² is a linear, branched or cyclic alkyl radical or an aryl radical or an oxy-alkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a sugar, for example glucose, fructose, maltose, lactose, galactose, mannose or xylose. The N-alkoxy- or N-aryloxy-substituted compounds can be converted into the desired polyhydroxy fatty acid amides, for example, by reaction with fatty acid methyl esters in the presence of an alkoxide as catalyst.

The anionic surfactants used are, for example, those of the sulfonate and sulfate type. Suitable surfactants of the sulfonate type are, preferably, C₉₋₁₃-alkylbenzenesulfonates, olefinsulfonates, i.e. mixtures of alkene- and hydroxyalkanesulfonates, and disulfonates, as obtained, for example, from C₁₂₋₁₈-monoolefins having a terminal or internal double bond by sulfonation with gaseous sulfur trioxide and subsequent alkaline or acidic hydrolysis of the sulfonation products. Also suitable are alkanesulfonates, which are obtained from C₁₂₋₁₈-alkanes, for example by sulfochlorination or sulfoxidation with subsequent hydrolysis or neutralization. Also suitable are the esters of α-sulfo fatty acids (ester sulfonates), e.g. the α-sulfonated methyl esters of hydrogenated coconut, palm kernel or tallow fatty acids.

Preferred alk(en)ylsulfates are the alkali metal, and in particular sodium, salts of sulfuric half-esters of C₁₂-C₁₈-fatty alcohols, for example from coconut fatty alcohol, tallow fatty alcohol, lauryl, myristyl, cetyl or stearyl alcohol, or of C₁₀-C₂₀-oxo alcohols and those half-esters of secondary alcohols of these chain lengths. Also preferred are alk(en)ylsulfates of said chain length which contain a synthetic straight-chain alkyl radical prepared on the basis of petroleum. From a washing-performance viewpoint, the C₁₂-C₁₆-alkylsulfates and C₁₂-C₁₅-alkylsulfates, and C₁₄₋C₁₅-alkylsulfates are preferred. 2,3-Alkylsulfates are also suitable anionic surfactants.

Further suitable anionic surfactants are sulfated fatty acid glycerol esters. Fatty acid glycerol esters means the mono-, di- and triesters, and mixtures thereof, as are obtained during the preparation by esterification of a monoglycerol with 1 to 3 mol of fatty acid or during the transesterification of triglycerides with 0.3 to 2 mol of glycerol. Preferred sulfated fatty acid glycerol esters are the sulfation products of saturated fatty acids having 6 to 22 carbon atoms, for example of caproic acid, caprylic acid, capric acid, myristic acid, lauric acid, palmitic acid, stearic acid or behenic acid.

The sulfuric monoesters of the straight-chain or branched C₇₋₂₁-alcohols ethoxylated with 1 to 6 mol of ethylene oxide, such as 2-methyl-branched C₉₋₁₁-alcohols having, on average, 3.5 mol of ethylene oxide (EO) or C₁₂₋₁₈-fatty alcohols having from 1 to 4 EO, are also suitable. Because of their high foaming behavior, they are only used in surfactant compositions or cleaners in relatively small amounts, for example in amounts of from 1 to 5% by weight.

Further suitable anionic surfactants are also the salts of alkylsulfosuccinic acid, which are also referred to as sulfosuccinates or as sulfosuccinic esters, and which represent monoesters and/or diesters of sulfosuccinic acid with alcohols, preferably fatty alcohols and, in particular, ethoxylated fatty alcohols. Preferred sulfosuccinates contain C₈₋₁₈-fatty alcohol radicals or mixtures thereof. Particularly preferred sulfosuccinates contain a fatty alcohol radical derived from ethoxylated fatty alcohols which, viewed per se, are nonionic surfactants (see below for description). Here, sulfosuccinates whose fatty alcohol radicals are derived from ethoxylated fatty alcohols with a narrowed homologue distribution are in turn particularly preferred. Likewise, it is also possible to use alk(en)ylsuccinic acid having, preferably, 8 to 18 carbon atoms in the alk(en)yl chain or salts thereof.

Suitable further anionic surfactants are, in particular, soaps, which are used in particular at relatively high pHs. Saturated and unsaturated fatty acid soaps, such as the salts of lauric acid, myristic acid, palmitic acid, stearic acid, hydrogenated erucic acid and behenic acid, and soap mixtures derived, in particular, from natural fatty acids, e.g. coconut, palm kernel, olive oil or tallow fatty acids, are suitable.

The anionic surfactants, including the soaps, can be present in the form of their sodium, potassium or ammonium salts, and as soluble salts of organic bases, such as mono-, di- or triethanolamine. The anionic surfactants are preferably in the form of their sodium of potassium salts, in particular in the form of the sodium salts.

A further group of ingredients are the builders. Here, all builders customarily used in detergents and cleaners may be present in the detergents and cleaners according to the invention, i.e. in particular zeolites, silicates, carbonates, organic cobuilders and, if there are no ecological arguments against their use, also the phosphates.

Suitable crystalline, layered sodium silicates have the general formula NaMSiₓO₂ₓ+1.H₂O, where M is sodium or hydrogen, x is a number from 1.9 to 4 and y is a number from 0 to 20, and preferred values for x are 2, 3 or 4. Preferred crystalline phyllosilicates of the given formula are those in which M is sodium and x assumes the value 2 or 3. In particular, both β- and δ-sodium disilicates Na₂Si₂O₅.yH₂O are preferred.

It is also possible to use amorphous sodium silicates having an Na₂O:SiO₂ modulus of from 1:2 to 1:3.3, preferably from 1:2 to 1:2.8 and in particular from 1:2 to 1:2.6, which have delayed solubility and secondary detergency properties. The dissolution delay relative to conventional amorphous sodium silicates can have been induced in various ways, for example by surface treatment, compounding, compaction/compression or by overdrying. Within the scope of this invention, the term “amorphous” also means “X-ray-amorphous”. This means that in X-ray diffraction experiments, the silicates do not give sharp X-ray reflections typical of crystalline substances, but, at best, one or more maxima of the scattered X-ray radiation, which have a width of several degree units of the angle of diffraction. However, it is very probable that particularly good builder properties may result if, in electron diffraction experiments, the silicate particles give poorly defined or even sharp diffraction maxima. This is to be interpreted to the effect that the products have microcrystalline regions of size 10 to a few hundred nm, values up to a maximum of 50 nm and in particular up to a maximum of 20 nm being preferred. Particular preference is given to compressed/compacted amorphous silicates, compounded amorphous silicates and overdried X-ray-amorphous silicates.

The finely crystalline, synthetic zeolite which contains bonded water which is used is preferably zeolite A and/or P. Zeolite P is particularly preferably Zeolith MAP® (commercial product from Crosfield). Also suitable, however, are zeolite X and mixtures of A, X and/or P. A zeolite which is commercially available and can be used with preference within the scope of the present invention is, for example, also a cocrystallisate of zeolite X and zeolite A (about 80% by weight of zeolite X), which is sold by CONDEA Augusta S.p.A. under the trade name VEGOBOND AX® and can be described by the formula

nNa₂O.(1−n)K₂O.Al₂O₃.(2−2.5)SiO₂.(3.5−5.5)H₂O.

Suitable zeolites have an average particle size of less than 10 μm (volume distribution; measurement method: Coulter counter) and preferably contain 18 to 22% by weight, in particular 20 to 22% by weight, of bonded water.

It is of course also possible to use the generally known phosphates as builder substances, provided such a use should not be avoided for ecological reasons. Of the large number of commercially available phosphates, the alkali metal phosphates, particularly preferably pentasodium or pentapotassium triphosphate (sodium or potassium tripolyphosphate), are of the greatest importance in the detergents and cleaners industry.

Alkali metal phosphates is the collective term for the alkali metal (in particular sodium and potassium) salts of the various phosphoric acids, among which metaphosphoric acids (HPO₃)ₙ and orthophosphoric acid H₃PO₄, in addition to higher molecular weight representatives, may be differentiated. The phosphates combine a number of advantages: they act as alkali carriers, prevent limescale deposits on machine components, and lime incrustations in fabrics, and additionally contribute to the cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders which are very readily soluble in water, which lose the water of crystallization upon heating and undergo conversion at 200° C. into the weakly acidic diphosphate (disodium hydrogendiphosphate, Na₂H₂P₂O₇), at a higher temperature into sodium trimetaphosphate (Na₃P₃O₉) and Maddrell's salt (see below). NaH₂PO₄ is acidic; it is formed if phosphoric acid is adjusted to a pH of 4.5 using sodium hydroxide solution and the slurry is sprayed. Potassium dihydrogenphosphate (primary or monobasic potassium phosphate, potassium biphosphate, PDP), KH₂PO_{4,} is a white salt of density 2.33 gcm⁻³, has a melting point of 253° [decomposition with the formation of potassium polyphosphate (KPO₃)ₓ] and is readily soluble in water.

Disodium hydrogenphosphate (secondary sodium phosphate), Na₂HPO₄, is a colorless, very readily water-soluble crystalline salt. It exists in anhydrous form and with 2 mol of water (density 2.066 gcm⁻³, water loss at 95°), 7 mol of water (density 1.68 gcm⁻³, melting point 48° with loss of 5 H₂O) and 12 mol of water (density 1.52 gcm⁻³, melting point 35° with loss of 5 H₂O), becomes anhydrous at 100° and converts to the diphosphate Na₄P₂O₇ upon more severe heating. Disodium hydrogenphosphate is prepared by neutralizing phosphoric acid with soda solution using phenolphthalein as indicator. Dipotassium hydrogenphosphate (secondary or dibasic potassium phosphate), K₂HPO₄, is an amorphous white salt which is readily soluble in water.

Trisodium phosphate, tertiary sodium phosphate, Na₃PO₄, are colorless crystals which as the dodecahydrate have a density of 1.62 gcm⁻³ and a melting point of 73-76° C. (decomposition), as the decahydrate (corresponding to 19-20% of P₂O₅) have a melting point of 100° C. and in anhydrous form (corresponding to 39-40% of P₂O₅) have a density of 2.536 gcm-⁻³. Trisodium phosphate is readily soluble in water with an alkaline reaction and is prepared by evaporative concentration of a solution of exactly 1 mol of disodium phosphate and 1 mol of NaOH. Tripotassium phosphate (tertiary or tribasic potassium phosphate), K₃PO₄, is a white, deliquescent, granular powder of density 2.56 gcm⁻³, has a melting point of 1340° and is readily soluble in water with an alkaline reaction. It is produced, for example, when Thomas slag is heated with charcoal and potassium sulfate. Despite the relatively high price, the more readily soluble and therefore highly effective potassium phosphates are often preferred in the cleaners industry over corresponding sodium compounds.

Tetrasodium diphosphate (sodium pyrophosphate), Na₄P₂O₇, exists in anhydrous form (density 2.534 gcm⁻³, melting point 988°, 880° also reported) and as the decahydrate (density 1.815-1.836 gcm⁻³, melting point 94° with loss of water). Both substances are colorless crystals which are soluble in water with an alkaline reaction. Na₄P₂O₇ is formed when disodium phosphate is heated at >200° or by reacting phosphoric acid with soda in the stoichiometric ratio and dewatering the solution by spraying. The decahydrate complexes heavy metal salts and water hardness constituents and therefore reduces the hardness of the water. Potassium diphosphate (potassium pyrophosphate), K₄P₂O₇, exists in the form of the trihydrate and is a colorless, hygroscopic powder with a density of 2.33 gcm⁻³ which is soluble in water, the pH of the 1% strength solution at 25° being 10.4.

Condensation of the NaH₂PO₄ or of the KH₂PO₄ gives rise to higher molecular weight sodium and potassium phosphates, among which it is possible to differentiate between cyclic representatives, the sodium and potassium metaphosphates and catenated types, the sodium and potassium polyphosphates. For the latter, in particular, a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, about 20 g dissolve at 60° C., and about 32 g dissolve at 100°; after heating the solution for 2 hours at 100°, about 8% orthophosphate and 15% diphosphate are produced by hydrolysis. In the case of the preparation of pentasodium triphosphate, phosphoric acid is reacted with soda solution or sodium hydroxide solution in the stoichiometric ratio and the solution is dewatered by spraying. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is commercially available, for example, in the form of a 50% strength by weight solution (>23% P₂O₅, 25% K₂O). The potassium polyphosphates are widely used in the detergents and cleaners industry. There also exist sodium potassium tripolyphosphates, which can likewise be used within the scope of the present invention. These form, for example, when sodium trimetaphosphate is hydrolyzed with KOH:

(NaPO₃)₃+2 KOH→Na₃K₂P₃O₁₀+H₂O.

These can be used in accordance with the invention in exactly the same way as sodium tripolyphosphate, potassium tripolyphosphate or mixtures of the two; according to the invention, it is also possible to use mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate.

Organic cobuilders which may be used in the machine dishwashing detergents according to the invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which can be used are, for example, the polycarboxylic acids usable in the form of their sodium salts, the term polycarboxylic acids meaning carboxylic acids which carry more than one acid function. Examples of these are citric acid, adipic acid, succinic acid, glutaric acid, mallic acid, tartaric acid, maleic acid, fumaric acid, sugar acids, aminocarboxylic acids, nitrilotriacetic acid (NTA), provided such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids per se may also be used. In addition to their builder action, the acids typically also have the property of an acidifying component and thus also serve to establish a lower and milder pH of detergents or cleaners. In this connection, particular mention is made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70 000 g/mol.

The molar masses given for polymeric polycarboxylates are, for the purposes of this specification, weight-average molar masses, M_{w} of the respective acid form, determined fundamentally by means of gel permeation chromatography (GPC) using a UV detector. The measurement was made against an external polyacrylic acid standard which, owing to its structural similarity to the polymers under investigation, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Suitable polymers are, in particular, polyacrylates which preferably have a molecular mass of from 2000 to 20 000 g/mol. Owing to their superior solubility, preference in this group may be given in turn to the short-chain polyacrylates which have molar masses of from 2000 to 10 000 g/mol and particularly preferably from 3000 to 5000 g/mol.

Also suitable are copolymeric polycarboxylates, in particular those of acrylic acid with methacrylic acid and of acrylic acid or methacrylic acid with maleic acid. Copolymers which have proven to be particularly suitable are those of acrylic acid with maleic acid which contain from 50 to 90% by weight of acrylic acid and 50 to 10% by weight of maleic acid. Their relative molecular mass, based on free acids, is generally 2000 to 70 000 g/mol, preferably 20 000 to 50 000 g/mol and in particular 30 000 to 40 000 g/mol.

The (co)polymeric polycarboxylates can either be used as powders or as aqueous solutions. The (co)polymeric polycarboxylate content of the composition is preferably 0.5 to 20% by weight, in particular 3 to 10% by weight.

To improve the solubility in water, the polymers can also contain allylsulfonic acids, such as, for example, allyloxybenzenesulfonic acid and methallylsulfonic acid, as monomer.

Particular preference is also given to biodegradable polymers of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallyl-sulfonic acid, and sugar derivatives.

Further preferred copolymers are those which preferably have, as monomers, acrolein and acrylic acid/acrylic acid salts or acrolein and vinyl acetate.

Further preferred builder substances which may be mentioned are also polymeric aminodicarboxylic acids, their salts or their precursor substances. Particular preference is given to polyaspartic acids or salts and derivatives thereof.

Further suitable builder substances are polyacetals, which can be obtained by reacting dialdehydes with polyolcarboxylic acids which have 5 to 7 carbon atoms and at least 3 hydroxyl groups. Preferred polyacetals are obtained from dialdehydes such as glyoxal, glutaraldehyde, terephthalaldehyde and mixtures thereof and from polyolcarboxylic acids such as gluconic acid and/or glucoheptonic acid.

Further suitable organic builder substances are dextrins, examples being oligomers or polymers of carbohydrates, which can be obtained by partial hydrolysis of starches. The hydrolysis can be carried out by customary processes, for example acid-catalyzed or enzyme-catalyzed processes. The hydrolysis products preferably have an average molar mass in the range from 400 to 500 000 g/mol. Preference is given here to a polysaccharide having a dextrose equivalent (DE) in the range from 0.5 to 40, in particular from 2 to 30, where DE is a common measure of the reducing effect of a polysaccharide compared with dextrose, which has a DE of 100. It is also possible to use both maltodextrins having a DE between 3 and 20 and dried glucose syrups having a DE between 20 and 37, and also so-called yellow dextrins and white dextrins with higher molar masses in the range from 2000 to 30 000 g/mol.

The oxidized derivatives of such dextrins are their reaction products with oxidizing agents which are able to oxidize at least one alcohol function of the saccharide ring to the carboxylic acid function. A product oxidized on the C₆ of the saccharide ring is likewise suitable.

Oxydisuccinates and other derivatives of disuccinates, preferably ethylenediamine disuccinate, are also further suitable cobuilders. Here, ethylenediamine N,N′-disuccinate (EDDS) is preferably used in the form of its sodium or magnesium salts. In this connection further preference is also given to glycerol disuccinates and glycerol trisuccinates. Suitable use amounts in zeolite-containing and/or silicate-containing formulations are 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and at most two acid groups.

A further class of substance having cobuilder properties is the phosphonates. These are, in particular, hydroxyalkane- and aminoalkanephosphonates.

Among the hydroxyalkanephosphonates, 1-hydroxyethane-1,1-diphosphonate (HEDP) is of particular importance as a cobuilder. It is preferably used as sodium salt, the disodium salt being neutral and the tetrasodium salt being alkaline (pH 9). Suitable aminoalkanephosphonates are preferably ethylenediaminetetramethylenephosphonate (EDTMP), diethylenetriaminepentamethylenephosphonate (DTPMP) and higher homologues thereof. They are preferably used in the form of the neutral sodium salts, e.g. as the hexasodium salt of EDTMP or as the hepta- and octasodium salt of DTPMP. Here, preference is given to using HEDP as builder from the class of phosphonates. In addition, the aminoalkanephosphonates have a marked heavy metal-binding capacity. Accordingly, particularly if the compositions also contain bleaches, it may be preferable to use aminoalkanephosphonates, in particular DTPMP, or mixtures of said phosphonates.

Moreover, all compounds which are able to form complexes with alkaline earth metal ions can be used as cobuilders.

A further class of active substances which may be present in the compositions according to the invention are bleaches, which may be chosen from the group of oxygen or halogen bleaches, in particular chlorine bleaches.

Among the compounds which serve as bleaches and liberate H₂O₂ in water, sodium perborate tetrahydrate and sodium perborate monohydrate are of particular importance. Examples of further bleaches which may be used are sodium percarbonate, peroxypyrophosphate, citrate perhydrate, and H₂O₂-donating peracidic salts or peracids, such as perbenzoates, peroxophthalates, diperazelaic acid, phthaloiminoperacid or diperdodecanedioic acid. In the case of the use of bleaches as well it is possible to dispense with the use of surfactants and/or builders, so that pure bleach tablets can be prepared. If such bleach tablets are intended for textile washing, a combination of sodium percarbonate with sodium sesquicarbonate is preferred, regardless of which further ingredients are present in the moldings. If preparing cleaning or bleach tablets for machine dishwashing, then it is also possible to use bleaches from the group of organic bleaches. Typical organic bleaches are the diacyl peroxides, such as, for example, dibenzoyl peroxide. Further typical organic bleaches are the peroxy acids, particular examples being the alkylperoxy acids and the arylperoxy acids. Preferred representatives are (a) peroxybenzoic acid and its ring-substituted derivatives, such as alkylperoxybenzoic acid, but it is also possible to use peroxy-α-naphthoic acid and magnesium monoperphthalate, (b) aliphatic or substituted aliphatic peroxy acids such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinate, and (c) aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid and N,N-terephthaloyldi(6-aminopercaproic acid).

Compounds which release chlorine or bromine may also be present as bleaches. Among the materials which release chlorine or bromine, suitable examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof having cations such as potassium and sodium. Hydantoin compounds, such as 1,3-dichloro-5,5-dimethylhydantoin are likewise suitable. The compounds mentioned above are preferably used in dishwashing detergents, although it is not the intention to exclude their use in textile detergents.

In order to achieve an improved bleaching action, bleach activators can be incorporated into the compositions according to the invention. Bleach activators which may be used are compounds which, under perhydrolysis conditions, produce aliphatic peroxocarboxylic acids having, preferably, 1 to 10 carbon atoms, in particular 2 to 4 carbon atoms, and/or optionally substituted perbenzoic acid. Suitable substances are those which carry O- and/or N-acyl groups of said carbon number, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular 1,3,4,6-tetraacetylglycoluril (TAGU), N-acylimides, in particular N-nonanoylsuccinimide (NOSI), acylated phenolsulfonates, in particular n-nonanoyl or isononanoyloxybenzenesulfonate (n- or iso-NOBS), acylated hydroxycarboxylic acids, such as triethyl 0-acetylcitrate (TEOC), carboxylic anhydrides, in particular phthalic anhydride, isatoic anhydride and/or succinic anhydride, carboxamides, such as N-methyldiacetamide, glycolide, acylated polyhydric alcohols, in particular triacetin, ethylene glycol diacetate, isopropenyl acetate, 2,5-diacetoxy-2,5-dihydrofuran and the enol esters known from the German patent applications DE 196 16 693 and DE 196 16 767, and acetylated sorbitol and mannitol and/or mixtures thereof (SORMAN) described in European patent application EP 0 525 239, acylated sugar derivatives, in particular pentaacetylglucose (PAG), pentaacetylfructose, tetraacetylxylose and octaacetyllactose, and acetylated, optionally N-alkylated glucamine or gluconolactone, triazole or triazole derivatives and/or particulate caprolactams and/or caprolactam derivatives, preferably N-acylated lactams, for example N-benzoylcaprolactam and N-acetylcaprolactam, which are known from international patent applications WO-A-94/27970, WO-A-94/28102, WO-A-94/28103, WO-A-95/00626, WO-A-95/14759 and WO-A-95/17498. The hydrophilically substituted acylacetals known from German patent application DE-A-196 16 769, and the acyllactam described in German patent application DE-A-196 16 770 and international patent application WO-A-95/14075 are likewise used with preference. It is also possible to use the combinations of conventional bleach activators known from German patent application DE-A-44 43 177. It is also possible to use nitrile derivatives, such as cyanopyridines, nitrile quats and/or cyanamide derivatives. Preferred bleach activators are sodium 4-(octanoyloxy)benzenesulfonate, undecenoyloxybenzenesulfonate (UDOBS), sodium dodecanoyloxybenzenesulfonate (DOBS), decanoyloxybenzoic acid (DOBA, OBC 10) and/or dodecanoyloxybenzenesulfonate (OBS 12). Such bleach activators are present in the customary quantitative range from 0.01 to 20% by weight, preferably in amounts of from 0.1 to 15% by weight, in particular 1% by weight to 10% by weight, based on the total composition.

In addition to the conventional bleach activators, or instead of them, so-called bleach catalysts may also be present. These substances are bleach-boosting transition metal salts or transition metal complexes, such as, for example, Mn, Fe, Co, Ru or Mo salen complexes or carbonyl complexes. Mn, Fe, Co, Ru, Mo, Ti, V and Cu complexes with N-containing tripod ligands, and Co, Fe, Cu and Ru ammine complexes are also suitable as bleach catalysts, preference being given to using those compounds described in DE 197 09 284 A1.

Suitable enzymes in the detergents and cleaners according to the invention are, in particular, those from the classes of the hydrolases, such as the proteases, esterases, lipases or lipolytic enzymes, amylases, glycosyl hydrolases and mixtures of said enzymes. All of these hydrolases contribute to the removal of soilings such as protein-, grease- or starch-containing stains. For bleaching, it is also possible to use oxidoreductases. Especially suitable enzymatic active ingredients are those obtained from bacterial strains or fungi, such as Bacillus subtilis, Bacillus licheniformis, Streptomyceus griseus, Coprinus Cinereus and Humicola insolens, and from genetically modified variants thereof. Preference is given to using proteases of the subtilisin type, and in particular to proteases obtained from Bacillus lentus. Of particular interest here are enzyme mixtures, for example of protease and amylase or protease and lipase or lipolytic enzymes, or of protease, amylase and lipase or lipolytic enzymes, or protease, lipase or lipolytic enzymes, but in particular protease and/or lipase-containing mixtures or mixtures with lipolytic enzymes. Examples of such lipolytic enzymes are the known cutinases. Peroxidases or oxidases have also proven suitable in some cases. Suitable amylases include, in particular, alpha-amylases, isoamylases, pullulanases and pectinases.

The enzymes may be adsorbed on carrier substances or embedded in coating substances in order to protect them against premature decomposition. The proportion of enzymes, enzyme mixtures or enzyme granulates may, for example, be from about 0.1 to 5% by weight, preferably 0.5 to about 4.5% by weight. The enzymes can be used in washing and cleaning processes both during the heat treatment and also in the rinse cycle following the heat treatment, i.e. in the mixture with the LCST substance.

Dyes and fragrances may be added to the compositions according to the invention in order to improve the esthetic impression of the resulting products and to provide the consumer with performance coupled with a visually and sensorially “typical and unmistakable” product. Perfume oils or fragrances which may be used are individual odorant compounds, e.g. the synthetic products of the ester, ether, aldehyde, ketone, alcohol and hydrocarbon type. Odorant compounds of the ester type are e.g. benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether, and the aldehydes include, for example, the linear alkanals having 8-18 carbon atoms, citral, citronellal, citronellyloxyacetaldehyde, cyclamen aldehyde, hydroxycitronellal, lilial and bourgeonal, and the ketones include, for example, the ionones, α-isomethylionone and methyl cedryl ketone, and the alcohols include anethole, citronellol, eugenol, geraniol, linalool, phenylethyl alcohol and terpineol, and the hydrocarbons include primarily the terpenes, such as limonene and pinene. Preference is, however, given to using mixtures of different odorants which together produce a pleasing scent note. Such perfume oils can also contain natural odorant mixtures, as are obtainable from plant sources, e.g. pine oil, citrus oil, jasmine oil, patchouli oil, rose oil or ylang-ylang oil. Likewise suitable are clary sage oil, chamomile oil, oil of cloves, melissa oil, mint oil, cinnamon leaf oil, lime blossom oil, juniperberry oil, vetiver oil, olibanum oil, galbanum oil and labdanum oil, and orange blossom oil, neroliol, orange peel oil and sandalwood oil.

The fragrances can be incorporated directly into the cleaners according to the invention, although it may also be advantageous to apply the fragrances to carriers which intensify the adhesion of the perfume to the laundry and, by virtue of slower fragrance release, ensure long-lasting fragrance of the textiles. Materials which have become established as such carriers are, for example, cyclodextrins, in which case the cyclodextrin perfume complexes can additionally be coated with further auxiliaries. Incorporation into the composite material according to the invention is also possible, such that the fragrances are released only in the clear-rinse cycle, leading to a scent impression upon opening the machine.

In a preferred embodiment of the present invention, the composite material incorporated into the compositions according to the invention comprises surfactants as active ingredients. The presence of surfactants in the clear-rinse cycle of a machine dishwashing process has a positive effect on the shine and reduces lime deposits. The active ingredients usually used in the clear-rinse cycle are only low-foaming nonionic surfactants, although it is not the intention to exclude the use of other surfactants, e.g. anionic surfactants.

As further active ingredients which can be incorporated into the composite material and also released as early as in the main rinse or wash cycle, the compositions used as machine dishwashing detergents may comprise corrosion inhibitors. The corrosion inhibitors are present, in particular, for protecting the ware or the machine, particular importance being given to silver protectants in particular in the field of machine dishwashing. The known substances of the prior art may be used. In general, it is possible to use, in particular, silver protectants chosen from the group of triazoles, benzotriazoles, bisbenzotriazoles, aminotriazoles, alkylaminotriazoles and transition metal salts or complexes. Particular preference is given to using benzotriazole and/or alkylaminotriazole. Moreover, cleaning formulations frequently contain active-chlorine-containing compositions, which are able to significantly reduce the corrosion of the silver surface. In chlorine-free cleaners, use is made in particular of oxygen- and nitrogen-containing organic redox-active compounds, such as divalent and trivalent phenols, e.g. hydroquinone, pyrocatechol, hydroxyhydroquinone, gallic acid, phloroglucinol, pyrogallol, and derivatives of these classes of compound. Inorganic compounds in the form of salts and complexes, such as salts of the metals Mn, Ti, Zr, Hf, V, Co and Ce, are frequently used. Preference is given here to using the transition metal salts chosen from the group of manganese and/or cobalt salts and/or complexes, particular preference being given to cobalt (ammine) complexes, cobalt (acetato) complexes, cobalt (carbonyl) complexes, the chlorides of cobalt or of manganese and manganese sulfate. Zinc compounds can likewise be used for preventing corrosion on the ware.

Detergents and cleaners which are used for washing textiles can comprise, as active ingredients which are released only in the rinse cycle, cationic surfactants. Examples of the cationic surfactants which can be used in the compositions according to the invention are, in particular, quaternary ammonium compounds. Preference is given to ammonium halides, such as alkyltrimethylammonium chlorides, dialkyldimethylammonium chlorides and trialkylmethylammonium chlorides, e.g. cetyltrimethylammonium chloride, stearyltrimethylammonium chloride, distearyldimethylammonium chloride, lauryldimethylammonium chloride, lauryldimethylbenzylammonium chloride and tricetylmethylammonium chloride. Further cationic surfactants which can be used according to the invention are the quaternized protein hydrolysates.

Also suitable according to the invention are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, also referred to as amodimethicone), SM-2059 (manufacturer: General Electric), SLM-55067 (manufacturer: Wacker), and Abil®-Quat 3270 and 3272 (manufacturer: Th. Goldschmidt; diquaternary polydimethylsiloxane, quaternium-80).

Alkylamidoamines, in particular fatty acid amidoamines, such as stearylamidopropyldimethylamine obtainable under the name Tego Amide®S 18, are notable not only for their good conditioning action, but in particular for their good biodegradability.

Also very biodegradable are quaternary ester compounds, so-called “ester quats”, such as the methylhydroxyalkyldialkoyloxyalkylammonium methosulfates sold under the trade name Stepantex®.

An example of a quaternary sugar derivative which can be used as cationic surfactant is the commercial product Glucquat® 100, according to CTFA nomenclature a “Lauryl Methyl Gluceth-10 Hydroxypropyl Dimonium Chloride”.

The detergents and cleaners according to the invention can be in solid to gel form and also in the form of powders, granulates, extrudates or as moldings (tablets). The individual forms can be prepared by customary preparation processes known to the person skilled in the art from the prior art.

The composition according to the invention comprises the active ingredient in the form of the above-described composite material, so that the active ingredient is not released, or is released only in a minor amount, in the main rinse or wash cycle (and also in optional prewash cycles). This results in the active ingredients only developing their action in the clear-rinse cycle. In addition to this chemical formulation, depending on the type of dishwashing machine or laundry washing machine, a physical assembly is required so that the active ingredient-containing composite material is not pumped out when the water in the machine is changed and thus is no longer available for the clear-rinse cycle.

Standard domestic dishwashers include, for example upstream of the liquor pump, which pumps the water or the cleaning solution from the machine after the individual cleaning cycles, a screen insert, which is intended to prevent clogging of the pump by soil residues. The composite material is preferably formulated with regard to its size and shape such that it does not pass through the screen insert of the dishwasher after the cleaning cycle, i.e. after exposure to agitation in the machine and the cleaning solution. This ensures that the active ingredient is present in the clear-rinse cycle and is only released in this rinse cycle and brings the desired rinse effect. Within the scope of the present invention, preferred machine dishwashing detergents are those in which the material comprising the active ingredient or the active ingredient itself is formulated such that it has particle sizes between 2 and 30 mm, preferably between 2.5 and 25 mm and in particular between 3 and 20 mm.

In an embodiment of the present invention, the composite material is mixed into pulverulent or granular machine dishwashing detergents.

In a further preferred embodiment, composite material is processed together with the ingredients of the machine dishwashing detergent to give a combination product of dishwashing detergent and rinse aid. Such products are preferably so-called moldings, also referred to in the prior art as tablets.

The combination products can be prepared in a manner known per se. In one possible embodiment, the moldings and the composite material according to the invention are prepared separately and then combined with one another, it being possible here for the moldings to already have recesses prefabricated for the particles. The combination can take place, for example, by simple insertion into the recess or adhesion of the two solid components.

In a further embodiment, the composite material according to the invention or the premix therefor is processed in a suitable tabletting device with the premix for the dishwashing detergent to give moldings.

In the detergents and cleaners according to the invention, the composite material containing the active ingredient and having the abovementioned sizes may project from the matrix of the other particulate ingredients; however, the other particles can likewise have sizes within said range, so that, overall, a detergent and cleaner is formulated which consists of large detergent particles and particles containing the active ingredient. Particularly if the particles containing the active ingredient are colored, i.e. have a red, blue, green or yellow color, for example, it is advantageous for optical reasons for the appearance of the product, i.e. the overall detergent, if these particles are visibly larger than the matrix comprising the particles of the other ingredients of the composition. Preference is given here to particulate detergents and cleaners according to the invention which (without taking into account the rinse aid particles) have particle sizes between 200 and 3000 μm, preferably between 300 and 2500 μm and in particular between 400 and 2000 μm.

As well as coloring the composite material, the visual attractiveness of such compositions may also be enhanced by contrasting coloration of the powder matrix or by the shape of the composite material. Since it is possible to use technically uncomplicated techniques to produce the composite material, it is readily possible to offer them in a wide variety of shapes. In addition to the particle shape, which approximates to the spherical form, for example, cylindrical or cuboid particles may be prepared and used. Other geometric shapes may also be realized. Specific product designs may include, for example, star-shaped composite material. Disks or shapes with plants and animal bodies as their base, for example tree, flower, blossom, sheep, fish, etc., can also be prepared without problems. Interesting visual attractions may also be created in this way by, if the composite material is released in the clear-rinse cycle of a machine dishwashing process, preparing it in the form of a stylized glass, in order to visually emphasize the clear-rinse effect in the product as well. The imagination knows no bounds in this respect.

If the detergents according to the invention are formulated as a powder mixture, then, especially if there are large differences between the size of composite material, for example the rinse aid particles, and the detergent matrix—firstly, partial separation may occur when the pack is subjected to shaking, and secondly dosing may be different in two successive cleaning operations since the consumer does not always automatically dose equal amounts of detergent and composite material, e.g. rinse aid. If it is desired technically to always use an identical amount per wash cycle, this can be realized by the packaging, familiar to the person skilled in the art, of the compositions according to the invention in bags made of water-soluble film. Particulate detergents and cleaners in which one dose unit is welded into a bag made of water-soluble film are also provided by the present invention.

As a result, the user needs only to insert a bag, which contains, for example, a detergent powder and two or more optically distinctive active ingredients which have been incorporated in the composite material, into the dispensing compartment of his or her washing machine or dishwasher. This embodiment of the present invention is therefore a visually attractive alternative to conventional detergent tablets.

### EXAMPLE

A machine dishwashing detergent is prepared in the following way: 60% by weight of clear-rinse surfactant (Polytergent SLF 18 B 45 from Olin Chemicals) are applied to 20% by weight of carrier material (PolyTrap from Advanced Polymer Systems) to give a flowable granulate. 20% by weight of a 10% strength solution of poly-N-isopropyl-acrylamide (PIPAAm) in acetone are mixed into this granulate. After the solvent has been largely removed by evaporation, the resulting granulate is compressed in a tabletting press to give compacts weighing about 1 g. These compacts are then coated with paraffin (melting point 50° C.) in the immersion process.

This preparation is dosed in various ways together with a usual dishwashing detergent (Somat; commercial product from the applicant):

1. It is added together with commercially available Somat powder detergent to the dosing compartment of the dishwasher.

2. It is stuck into a cavity of a Somat detergent tablet or introduced loose.

3. It is introduced in a tablet press into the loose premix of a Somat detergent tablet and pressed together with this to give a molding.

The function of these detergent formulations is then tested in a commercially available domestic dishwasher from Miele G 683SC. In all cases it is found, as desired, that the Somat detergent dissolves in the wash cycle (55° C. or 65° C. program as desired) both as a powder and also as a tablet, while the formulation comprising the rinse aid is retained until the start of the clear-rinse cycle. It breaks up in the first few minutes of the clear-rinse cycle and releases the clear-rinse surfactant as desired.

1. A particulate composite material for the controlled release of an active ingredient, comprising an active ingredient or a preparation which comprises this active ingredient in a mixture with an LCST substance, where the material remains at least partially unchanged upon passing through one or more heat treatments in a liquid medium, and after cooling following the heat treatment the active ingredient is released.

2. The composite material as claimed in claim 1, wherein the active ingredient preparation is embedded in a matrix of an LCST substance.

3. Composite material as claimed in claim 1 or 2, wherein the LCST polymer is chosen from alkylated and/or hydroxyalkylated polysaccharides, cellulose ethers, polyisopropylacrylamide, copolymers of polyisopropylacrylamide, and blends of these substances.

4. Composite material as claimed in one of claims 1 to 3, wherein the LCST temperature is between 20° C. and 100° C.

5. Composite material as claimed in one of claims 1 to 4, wherein the heat treatment is carried out at a temperature between 20° C. and 150° C., preferably between 30° C. and 95° C.

6. The composite material as claimed in one of claims 1 to 5, wherein it is coated with a further substance which is soluble at a temperature above the lower separation temperature of the LCST substance or has a melting point above this temperature or delayed solubility.

7. The use of the composite material as claimed in one of claims 1 to 6 in pharmaceutical and cosmetic products, preservatives, foods, growth regulators, dies, fragrances, pesticides and herbicides, adhesives, and detergents and cleaners.

8. A detergent or cleaner comprising customary ingredients, which comprises a particulate composite material for the controlled release of an active ingredient or a preparation which comprises the active ingredient in a mixture with a substance with a lower critical separation temperature, where the material remains at least partially unchanged upon passing through one or more heat treatments in a liquid medium, and after cooling following the heat treatment is released.

9. The detergent or cleaner as claimed in claim 8, in solid form, in particular as a powder, granulate, extrudate or as moldings.

10. The detergent or cleaner as claimed in either of claims 8 and 9, which is a textile detergent and wherein the active ingredients are finishing components, enzymes, fragrances, dyes, fluorescent agents, optical brighteners, antishrink agents, anticrease agents, antimicrobial active ingredients, germicides, fungicides, antioxidants, antistats, ironing aids, phobicization agents and impregnation agents, UV absorbers and any mixtures of the above.

11. The detergent or cleaner as claimed in either of claims 8 and 9, which is a machine dishwashing detergent and wherein the active ingredient comprises rinse aids, surfactants, fragrances, dyes, deposit inhibitors, corrosion inhibitors, or bleaches, preferably an active-chlorine carrier.

12. The detergent or cleaner as claimed in claim 11, wherein the composite material comprises a particular rinse aid.

13. The detergent or cleaner as claimed in claim 12, wherein the particular rinse aid has particle sizes between 2 and 30 mm, preferably between 2.5 and 25 mm and in particular between 3 and 20 mm.

14. The detergent or cleaner as claimed in one of claims 11 to 13, wherein the composite material is mixed with pulverulent or granular machine dishwashing detergents.

15. The detergent or cleaner as claimed in one of claims 11 to 13, wherein the composite material is embedded in a molding.
